(19) United States
(12) Patent Application Publication
(10) Pub. No.: US 2023/0261210 A1
(43) Pub. Date: Aug. 17, 2023

(54) ADDITIVELY MANUFACTURED ELECTROLYSIS CELL

(71) Applicant: California Institute of Technology, Pasadena, CA (US)

(72) Inventors: John-Paul JONES, Pasadena, CA (US); Scott N. ROBERTS, Pasadena, CA (US); Keith J. BILLINGS, Pasadena, CA (US); Douglas C. HOFMANN, Pasadena, CA (US); Samad A. FIRDOSY, Pasadena, CA (US); Sarah D. LUDEMAN, Pasadena, CA (US)

(21) Appl. No.: 18/167,697

(22) Filed: Feb. 10, 2023

Related U.S. Application Data
(60) Provisional application No. 63/311,280, filed on Feb. 17, 2022.

(51) Int. Cl. H01M 4/88; H01M 4/86; B22F 10/28; B22F 10/366

(52) U.S. Cl. CPC H01M 4/8825; H01M 4/861; H01M 4/8636; H01M 4/8807; B22F 10/28; B22F 10/366; B33Y 10/00

(57) ABSTRACT

A monolithic electrode structure for use in electrochemical flow cells is presented. The monolithic electrode structure includes a dense region with embedded flow channels that provides functionality of a flow field layer and a porous region that provides combined functionalities of gas diffusion and catalyst layers. The monolithic electrode structure is additively fabricated to include regions of different porosities/densities. A material of the monolithic electrode structure is a pure metal that is a catalyst for a targeted electrochemical reaction, or an alloy that contains such pure metal. Porosity of the porous region is adjusted to allow flow of liquid, such as water, towards or away from an active surface of the electrode. According to one aspect, porosity is adjusted by adjusting the pore size that make the porous region. According to another aspect, the dense region contains cooling channels for cooling of the electrode.

### CROSS REFERENCE TO RELATED APPLICATIONS

The present application claims priority to and the benefit of co-pending U.S. provisional patent application Ser. No. 63/311,280 entitled “Additively Manufactured Co2 Electrolysis Cell”, filed on Feb. 17, 2022, the disclosure of which is incorporated herein by reference in its entirety.

### STATEMENT OF GOVERNMENT GRANT

This invention was made with government support under Grant No. 80NMO0018D0004 awarded by NASA (JPL). The government has certain rights in the invention.

### TECHNICAL FIELD

The present disclosure relates to fuel cell and electrolyzer-type systems. More particularly, it relates to monolithic electrode structures for use in such systems.

### BACKGROUND

Catalyst structure and humidity management are significant issues that must be addressed in the design of electrochemical flow cells, such as fuel cells and electrolyzers (e.g., electrolysis cells). Structures used in such cells must be stable and include high catalyst surface area, good electrical contact to electrodes, and also reject excess water that might otherwise clog pores in the structures and reduce performance. Prior art cells address these issues by incorporating a plurality of disparate material layers that are compressed to form a stacked structure. A failure or misalignment at any layer of the stacked structure may result in the failure of the entire cell. Some such electrochemical flow cells (e.g., electrolyzers) may also suffer from corrosion due to high potentials applied to the cell, so careful materials compatibility studies must be performed which often rule out incompatible materials which would otherwise be desirable.

FIG. 1A shows prior art cell (100a, e.g., electrolyzer) with a stacked structure that includes an electrically insulating membrane (EM, e.g., electrolyte, provides conduction path for ions/protons or other particles such as anions or ions) arranged between two electrodes: a cathode, C, and an anode, A, and an (external) electrical circuit (EC, e.g., power/voltage supply) for conduction of (external) current between the two electrodes. Each of the two electrodes includes a layered structure made of a conductive (e.g., metal) flow field layer/plate, FF, and a conductive (e.g., carbon or metal) gas diffusion layer, GDL. Each of the two electrodes may further include a conductive (e.g., metal) catalyst layer, CAT, that may be deposited on a surface of the gas diffusion layer, GDL, that is in contact with the membrane, EM. In some cell configurations, the catalyst layer, CAT, may be deposited on the surface of the membrane, EM, instead of the surface of the gas diffusion layer, GDL. Conductive materials used for each of the layers (e.g., FF, GDL, CAT) may be different and optimized for a particular functionality of a layer while being selected from a (reduced) list of compatible materials. Because such different conductive materials are stacked as layers, each interface between two such layers may add resistance to the electrodes for potentially added heat dissipation via electrons conduction though the layers. It should be noted that principle of operation of an electrochemical flow cell, including the prior art cell (100a) shown in FIG. 1A is well known in the art and outside the scope of the present disclosure.

As shown in FIG. 1A, the electrodes (e.g., C, A) of the prior art cell (100a) may include macroscopic flow channels, FC, machined/embedded in the respective flow field layer/plate, FF, for supplying a reactant (e.g., R_{C}, R_{A} through respective inlets) for the electrochemical reaction that takes place in the region of the catalyst layer, CAT, and removing products (e.g., P_{C}, P_{A} through respective outlets) and/or excess reactant (e.g., R_{C}, R_{A}, for example, H₂O) generated/left by the electrochemical reaction. A typical thickness of the flow field layer/plate, FF, may be in a range from about 2 mm to about 1 cm, a typical thickness of the gas diffusion layer, GDL, may be in a range from about 200 μm to about 400 μm, and a typical thickness of the catalyst layer, CAT, may be in a range from about 1 μm to about 10 μm. It should be noted that elements/structures shown in the figures of the present disclosure are not to scale.

In some cell configurations, issues of materials compatibility may be further exacerbated by a competition between a desired electrochemical reaction and possible undesired electrochemical side reactions. For example, in a CO₂ reduction reaction (CO2RR), water (H₂O) is required as a reactant to be oxidized at the anode to generate oxygen (O₂, oxygen evolution), but water may also be a reactant to (the undesired) hydrogen evolution reaction (HER). Such side reactions may be promoted by internal conditions during operation of the cell, including, for example, flow of the reactant, concentration/type of the reactant, temperature and current density. In some cases (e.g., CO2RR), it may be necessary to, for example, limit (i.e., reduce) the current density in order to reduce possibility of occurrence of a side reaction (e.g., HER). However, reduction of the current density may directly impact (i.e., increases) the size of the cell for a given/desired reaction rate. In other words, there may be a tradeoff between performance (e.g., reaction rate) and size, and therefore cost, of the cell.

Teachings according to the present disclosure address the above-described challenges and tradeoffs in the prior art electrochemical flow cells.

### SUMMARY

According to a first aspect of the present disclosure, a monolithic electrode structure for use in an electrochemical flow cell is presented, comprising: a dense region with embedded flow channels; and a porous region in contact with the dense region, the porous region configured to interact with the embedded flow channels for distribution of a reactant for an electrochemical reaction through the porous region, wherein the monolithic electrode structure is made from a metal that includes a catalyst for the electrochemical reaction.

According to a second aspect of the present disclosure, an electrochemical flow cell is presented, comprising: a membrane having a first membrane surface and a second membrane surface; an anode having a first anode surface in contact with the first membrane surface; and a cathode having a first cathode surface in contact with the second membrane surface, wherein each of the anode and the cathode includes a respective monolithic electrode structure that comprises: a dense region with embedded flow channels, the dense region defining a respective second anode or cathode surface; and a porous region in contact with the dense region, the porous region configured to interact with the embedded flow channels for distribution of a reactant for an electrochemical reaction through the porous region, the porous region containing the respective first anode or cathode surface, wherein the respective monolithic electrode structure is made from a metal that includes a catalyst for the electrochemical reaction.

According to a third aspect, a method for fabricating an electrode for an electrochemical flow cell is presented, the method comprising: fabricating the electrode as a monolithic structure via additive manufacturing, the additive manufacturing including a laser power bed fusion; and based on the fabricating, forming in the monolithic structure: a dense region with embedded flow channels; and a porous region in contact with the dense region, the porous region configured to interact with the embedded flow channels for distribution of a reactant for an electrochemical reaction through the porous region, wherein the fabricating includes using a metal that includes a catalyst for the electrochemical reaction.

Further aspects of the disclosure are provided in the description, drawings and claims of the present application.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure. Same reference designators refer to same features.

FIG. 1A shows a structure of prior art electrochemical flow cell.

FIG. 1B shows a cross-sectional view of the prior art cell of FIG. 1A.

FIG. 2A shows a structure of an electrochemical flow cell comprising monolithic electrode structures according to the present disclosure.

FIG. 2B shows a cross-sectional view of the cell of FIG. 2A.

FIG. 3 shows porosity regions of a monolithic electrode structure according to the present disclosure.

FIG. 4 shows cooling channels embedded in a monolithic electrode structure according to the present disclosure.

FIG. 5 shows a monolithic electrode structure according to the present disclosure with a non-planar shape.

FIG. 6 show some exemplary flow channel designs of a flow field layer.

### DETAILED DESCRIPTION

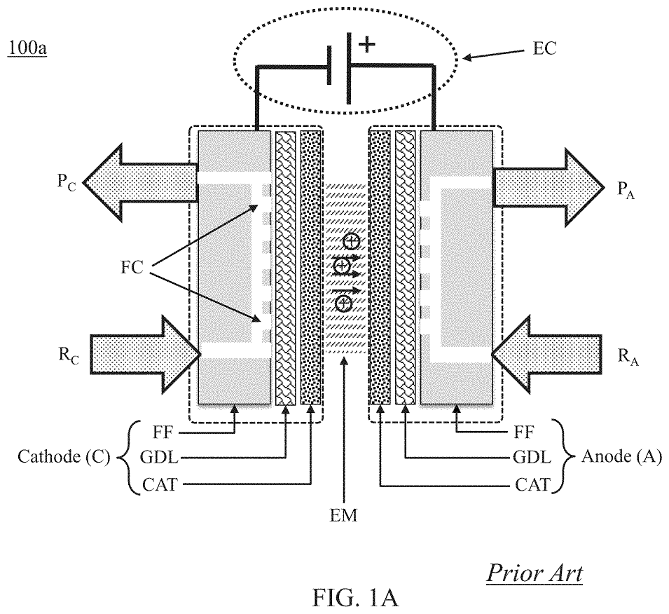

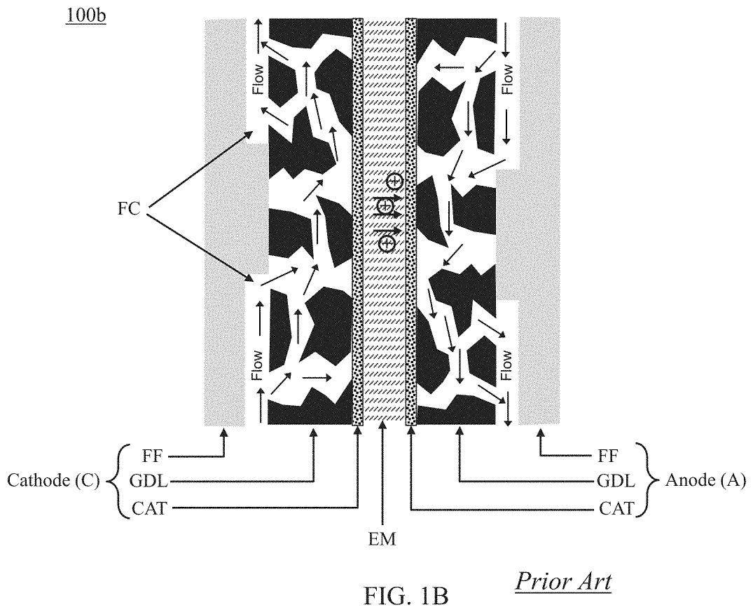

FIG. 1B shows a cross-sectional view (100b) of the prior art cell (100a) of FIG. 1A. In particular shown in FIG. 1B are the stacked structures (e.g., FF, GDL, CAT) that form each of the cathode, C, and anode, A, electrodes of the cell (100a). As shown in FIG. 1B, the flow channels, FC, formed in the flow field layer, FF, (made of a dense material) interact with void spaces (e.g., cavities, openings) provided by the porous material of the gas diffusion layer, GDL, to provide inflow/outflow paths to/from the catalyst layer, CAT, for the reactant and reaction products. Because the catalyst layer, CAT, is a thin layer, and because the bulk of the electrochemical reactions occur in, or immediately adjacent, the catalyst layer, CAT, a relatively high concentration of electrons generated by the electrochemical reaction at the cathode, C, may exist in and about the catalyst layer, CAT, thereby potentially introducing increased heat. Furthermore, as described above, such high current density may promote, in some cases, undesired side reactions (e.g., once the electrons are externally conducted to the anode).

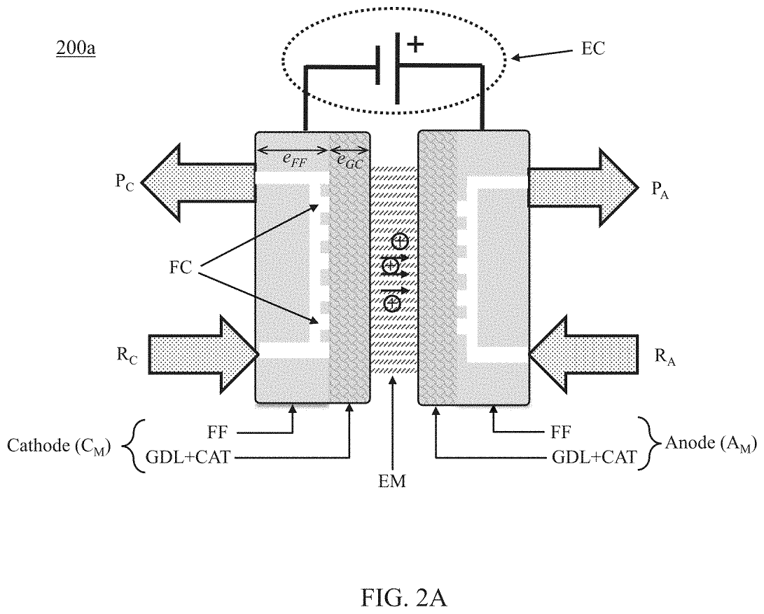

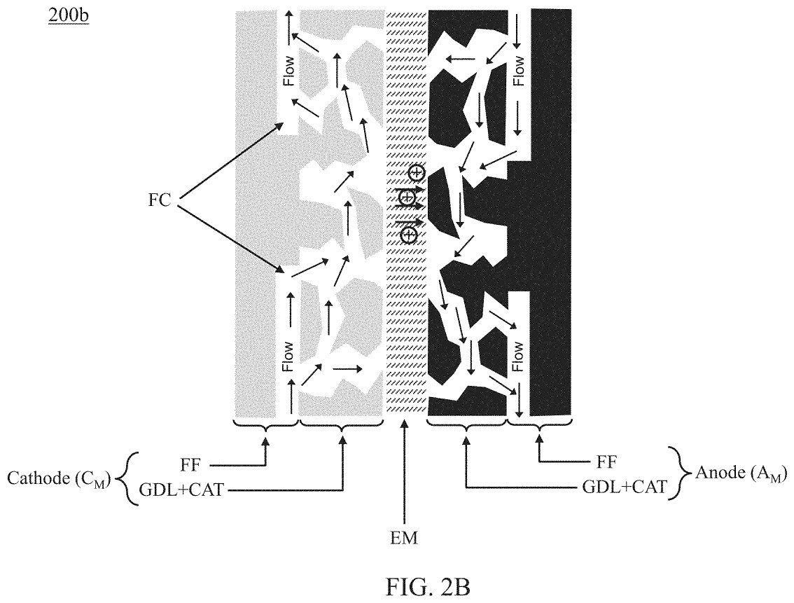

Teachings according to the present disclosure may eliminate issues related to the prior art electrodes made from different materials by forming, as shown in FIG. 2A, each (or at least one) of the two electrodes (e.g., C_{M}, A_{M}) of an electrochemical flow cell (200a) as a single monolithic electrode structure that provides the combined functionalities of the flow field layer, FF, the conductive gas diffusion layer, GDL, and the catalyst layer, CAT. It should be noted that the single monolithic electrode structure according to the present teachings may be used in both electrodes of an electrochemical flow cell (e.g., 200a of FIG. 2A), or just in one of the two electrodes while using a prior art stacked structure (e.g., according to FIG. 1A) for the other electrode.

As used herein, a monolithic structure may refer to a three-dimensional structure comprising functional elements (layers, regions) bonded to one another via atomic bonds of a material (or materials) that makes the structure. This may therefore include a single material structure formed via subtractive manufacturing, a single or multi material structure formed via additive manufacturing, or a combination of the two. Accordingly, a monolithic structure according to the present disclosure may not include any fasteners/bolts or welding/glue to form a three-dimensional shape of the structure. By reducing (e.g., integrating) a plurality of internal (functional) elements (e.g., FF, GDL, CAT of FIG. 2A) of an electrode to a single monolithic structure, enhanced thermal/electrical conductivity and increased catalytic volume/surface of such structure, and therefore of an electrochemical flow cell using such structure, may be provided.

Teachings according to the present disclosure may take advantage of additive manufacturing (AM) techniques that allow for the fabrication of complex parts not possible using traditional machining methods. In particular, such techniques may allow for tight control of the porosity of metal (including alloys) layers/regions in the single monolithic electrode structure according to the present teachings. AM fabrication techniques such as laser power bed fusion (LPBF) that may be used to form the single monolithic electrode structure may operate by melting particles of metal together using a laser. According to an embodiment of the present disclosure, control of density and porosity of the single monolithic electrode structure according to the present teachings may be provided by adjusting the laser power, scan speed (how fast the laser moves), and hatch spacing (distance between laser scans) parameters used during printing. These three parameters may combine to generate an energy density which may be directly correlated with the density (e.g., porosity) of the final printed part. By varying these three parameters in a controlled manner, the density, and therefore porosity, of a given material can be adjusted on the fly to form regions of different density/porosity for the single monolithic electrode structure according to the present teachings. Of the three parameters, hatch spacing may offer the coarsest adjustment for density/porosity because the farther apart the laser scans are, the more space between the (melted) particles of metal. On the other hand, a combination of laser power and scan speed which induces an instantaneous energy (e.g., heat) to the metal particles may allow fine adjustment of the density/porosity by controlling a degree by which the particles are melted (e.g., more melted then less spacing/granularity between particles).

Achievable density of the material of the single monolithic structure according to the present teachings may be in a range from 25% to 100% dense (e.g., ratio of volume of material to total volume) for an achievable porosity in a range from 75% to 0% (e.g., ratio of volume of void to total volume). Such flexibility in adjustment of the density/porosity in a single monolithic structure may allow forming of (adjacent) regions of largely differing density/porosity, such as, for example, a first region having a density that is equal to or greater than 95% and a second region adjacent the first region having a density that is smaller than 50%, such as, for example, smaller than 30% and down to 25%. As used herein, a dense region may be defined as a region having a density that is equal to or greater than 90% (i.e., porosity smaller than 10%), and a porous region may be defined as a region having a density that is smaller than 90% (i.e., porosity equal to or greater than 10%).

As shown in FIG. 2A, the single monolithic electrode structure (C_{M}, A_{M}) according to the present disclosure may include a first region (labeled as FF) to provide the functionality of the flow field layer, FF, including a dense region (e.g., impermeable to fluids in action) made from dense material with embedded flow channels, FC. Adjacent the first region, FF, there may be a second region (labeled as GDL+CAT) to provide the (combined) functionality of the conductive gas diffusion layer, GDL, and the catalyst layer, CAT. As shown in FIG. 2A, the second region, GDL+CAT, may be a porous region made from porous material with a controlled porosity to provide adequate flow of reactant/products to/from the flow channels, FC.

With further reference to FIG. 2A, dimensions of the various regions of the single monolithic electrode structure according to the present disclosure may be similar (or of the same order) to dimensions of corresponding regions of the prior art electrode. This includes, for example, a typical thickness (labelled in FIG. 2A as e_{FF}) of the first region, FF, that may be in a range from about 2 mm to about 1 cm, and a typical thickness (labelled in FIG. 2A as e_{GC}) of the second region, GDL+CAT, that may be in a range from about 200 μm to about 400 μm. It should be noted that such thicknesses are in view of typical planar shapes/geometries (e.g., rectangle, square, or other) of the first/second regions in a plane that is orthogonal to a direction of the thicknesses.

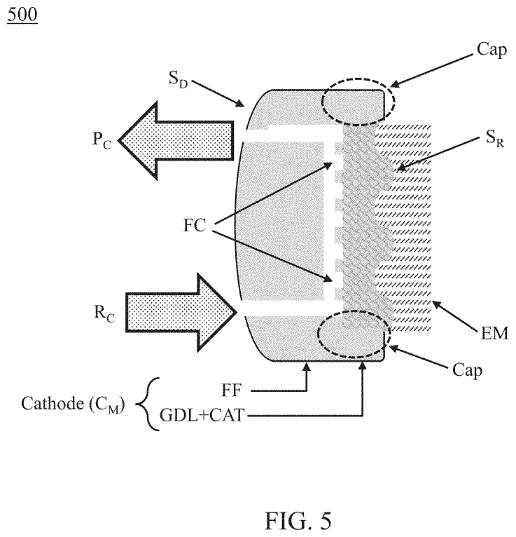

It should be further noted that although teachings according to the present disclosure may emulate prior art electrode shapes/geometries, such shapes/geometries, including planar shapes/geometries, should not be considered as limiting the scope of the present teachings. In other words, the single monolithic electrode structure according to the present teachings may include a non-planar shape/geometry, including, for example, regions of differing porosities/densities having non-planar shapes/geometries (and nominal thicknesses within ranges that may be different from the above-described ranges), an example of which is shown in FIG. 5 later described.

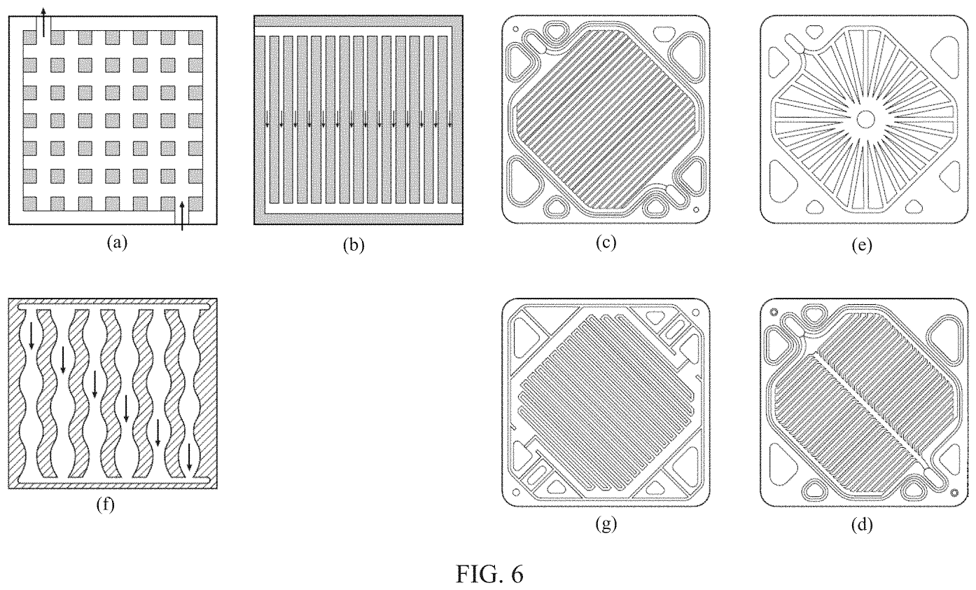

Furthermore, various known in the art flow channel designs/patterns may be formed/embedded in the single monolithic electrode structure according to the present teachings. Some such exemplary nonlimiting designs/patterns (with openings of the flow channels shown in clear and support/ribs of the flow channels shown in dark) are shown in FIG. 6, and may include, for example, a pin-type flow field channels according to FIG. 6(a), straight and parallel flow field channels according to FIG. 6(b), variations of the straight and parallel flow field channels according to FIG. 6(c) and FIG. 6(d), radial flow field channels according to FIG. 6(e), parallel flow field channels with undulation to promote pressure variation according to FIG. 6(f), and a single serpentine flow field channels according to FIG. 6(g). Typical dimensions of the flow channels in any direction may be in a range from 1 mm to 2 mm. Arrows in FIG. 6 may indicate direction of flow of fluid through the flow channels, including in some instances, corresponding inlet and outlet.

With continued reference to FIG. 2A, and in contrast to the prior art electrode (e.g., C, A of FIG. 1A), the single monolithic electrode structure (C_{M}, A_{M}) according to the present disclosure may not be vulnerable to misalignment (of layers of different functionalities). Furthermore, because the metal particles have been melted together, as opposed to simply pressed together using traditional fabrication techniques, increased electrical conductivity may be achieved in the single monolithic electrode structure (C_{M}, A_{M}) according to the present teachings. Due to the lack of different materials within the single monolithic electrode structure (C_{M}, A_{M}), possibility for corrosion may be reduced.

With further reference to FIG. 2A, according to an embodiment of the present disclosure, the single monolithic electrode structure (e.g., C_{M}, A_{M}) may be made of a single material or alloy selected for enabling a targeted electrochemical reaction of the cell. In other words, the entirety of the single monolithic structure made be made from a catalyst material or an alloy that includes a catalyst material. For example, and as shown in the cross-sectional view (200b) of FIG. 2B, the cathode, C_{M}, may be made from a first material (e.g., light grey) that is used as catalyst for the electrochemical reaction that occurs at the cathode side of the cell, and the anode, A_{M}, may be made from a second material (e.g., black) that is used as catalyst for the electrochemical reaction that occurs at the anode side of the cell. Accordingly, the entirety of the porous region, GDL+CAT, may become a catalytic volume for the targeted electrochemical reaction.

With reference to FIG. 2B, when compared to the prior art electrode (e.g., C, A of FIG. 2A), the single monolithic electrode structure according to the present teachings may provide a larger catalytic/reactive volume/surface, such as to provide, for example, for a lower current density and therefore increased reaction selectivity (and decreased side reactions). In other words, because the catalytic surface area of the single monolithic electrode structure (C_{M}, A_{M}) according to the present teachings may be provided by the entirety of the porous region, GDL+CAT, rather than a very thin catalyst layer (e.g., CAT of FIG. 2A) applied to the GDL according to the prior art electrode, then a targeted electrochemical reaction at an electrode (C_{M}, A_{M}) may be carried out under optimal current density conditions to enable maximum selectivity of the reaction. Relative to the prior art cell, this means that the current density may be lower and selectivity higher for a same reactor (e.g., electrode/membrane) volume. It follows that a same reaction performance may be obtained with the single monolithic electrode structure according to the present teachings having a lower overall volume when compared to the prior art electrode.

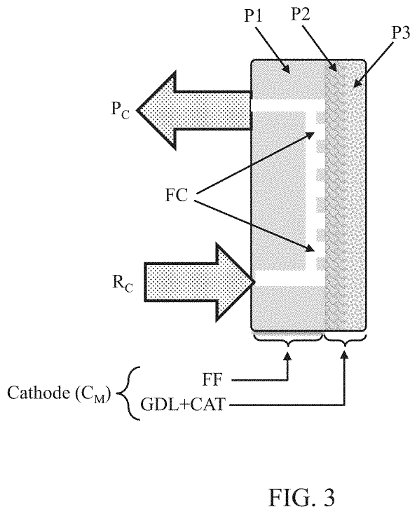

Porosity of the single monolithic electrode structure according to the present disclosure may be tightly adjusted/controlled to implement a desired flow of reactant and/or products, as well as a desired amount of catalytic surface provided by walls in the voids of the porous regions. For example, water (e.g., reactant) management may be tuned by adjusting the porosity of the regions of the electrode close to the membrane (e.g., EM of FIG. 2A) so to draw just enough water (e.g., reactant) to the reactive surface to enable a targeted electrochemical reaction (e.g., CO₂ reduction reaction, CO2RR, in an electrolyzer), but not so much to either clog the pores, or promote side reactions (e.g., HER). Adjusting of the porosity may be provided via a single region of a same porosity (e.g., GDL+CAT of FIG. 2A), or different regions of different porosities as shown in FIG. 3A.

According to an embodiment of the present disclosure, and as shown in FIG. 3, the monolithic electrode structure according to the present disclosure may include more than two regions of different porosities. For example, as shown in FIG. 3, functionality of the flow field layer, FF, may be provided by a dense (impermeable) region having a porosity P1, and a combined functionality of the gas diffusion and catalyst layers, GDL+CAT, may be provided by at least two regions having different porosities, P2 and P3. Because the porosity of the single monolithic electrode structure according to the present teachings may be tightly controlled, a large number of adjacent regions with different porosities may be formed (e.g., not limited to regions P1-P3). In some embodiments, the porosity of the region, GDL+CAT, may be provided by a gradient designed to achieve a desired effect, such as, for example, a desired fluid flow and/or a desired catalytic surface.

According to an embodiment of the present disclosure, porosity of the region, GDL+CAT, may be adjusted to implement a desired wicking process through capillary action. In this case, small (e.g., 1-10 μm sized) channels made from the void in the porous region may act as capillaries and draw liquid into the pores. The combination of surface tension on the liquid (e.g., water in the case of CO2RR) and adhesive force between the liquid and the material of the single monolithic electrode structure may act to propel the liquid into the porous region, possibly against a counteracting force like gravity or flow. Such behavior may be likened to water flowing up a porous material like paper against gravity when a portion of the paper is immersed into water. A similar process may occur in the porous region, GDL+CAT, of the single monolithic electrode structure according to the present teachings, where liquid (e.g., water) may be drawn from the flow channels (e.g., FC of FIG. 2A or FIG. 3) of the non-porous (e.g., dense) region, FF, to the (reactive) surface of the electrode that is in contact with the membrane (e.g., EM of FIG. 2A) through the capillary force. Porosity (profile) of the porous region, GDL+CAT, may be precisely controlled to direct the liquid (e.g., water) where it is most needed, and avoid flooding the electrode in region where the liquid may hinder activity. It should be noted that the small channels that act as capillaries may be considered as providing random paths for fluid flow based on a porosity of the porous region, GDL+CAT, provided by the input parameters (laser power, scan speed and hatch spacing), such porosity being a result of incomplete melting and fusing of the metal material (e.g., in powder form).

It should be noted that direction of the flow of the liquid provided via capillary action in view of a porosity of the single monolithic electrode structure according to the present teachings may be either towards the (active) surface of the electrode that is in contact with the membrane (e.g., EM of FIG. 2A), or away from such surface. For example, in the anode of an electrolyzer, water may be delivered as a reactant and therefore may be transported towards the reactive surface to react, so a monolithic anode structure of porous channels with (monotonically) decreasing pore size in the direction of the reactive surface may be advantageous to aid in transportation of the water towards the reactive surface. On the other hand, in the cathode of the electrolyzer, water may be removed away from the reactive surface, so a monolithic anode structure of porous channels with (monotonically) decreasing pore size in the direction away from the reactive surface (e.g., towards an outlet) may be advantageous.

It should be noted that porosity may be measured as a ratio of volume of void to total volume (e.g., complement of density as a ratio of material to total volume). Porosity according to the present teachings may be tightly controlled to provide a desired porosity, but also a desired pore size/volume (e.g., size/volume of cavities of void). In other words, a same measure of porosity may be provided by different pore sizes, wherein the pore sizes may help in, for example, delivering desired capillary action/direction, and density/distribution of the pores may provide, in combination with the pore sizes, the measure of the porosity.

Teachings according to the present disclosure may apply to any type of electrochemical flow cell, including fuel cells, redox flow batteries, and electrolyzers (e.g., CO2RR, water-based electrolysis) using catalyst material compatible with additive manufacturing techniques and processes.

According to an exemplary nonlimiting embodiment of the present disclosure, the single monolithic electrode structure of the present teachings may be used in an electrolyzer for implementation of CO₂ reduction reaction (CO2RR) at the cathode and oxygen evolution (OER) at the anode. In such exemplary embodiment, the cathode may be the single monolithic electrode structure, C_{M}, of FIG. 2A or FIG. 3, made of a metal material including any one of: copper, copper alloys (e.g., bronze, brass and copper-aluminum), tin, lead, tin-lead alloys, indium, or alloys of these metals. On the other hand, the anode may be the single monolithic electrode structure, A_{M}, of FIG. 2A or FIG. 3, made of a metal material including any one of: titanium (e.g., used as a support material), platinum, iridium, palladium, and their oxides (e.g., used as catalysts) and alloys with other metals.

According to another exemplary embodiment of the present disclosure, the single monolithic electrode structure of the present teachings may be used in a redox (reduction-oxidation) flow battery. In such exemplary embodiment, the cathode and/or anode may be the single monolithic electrode structure, C_{M} and/or A_{M}, of FIG. 2A or FIG. 3, made of a metal material (e.g., used as active material) including any one of: vanadium, iron, chromium, ruthenium, nickel, zinc, cerium and alloys containing these metals.

Teachings according to the present disclosure may allow use of metal alloys (e.g., copper alloys such as bronze, brass, copper-aluminum) in addition to use of pure metals. Use of a metal alloy may advantageously allow selective etching of an AM printed electrode according to the present teachings after the printing, so to increase a surface area provided by one component of the alloy (e.g., a catalyst material) by etching away other components of the alloy. The increased surface area may further improve the kinetics of the targeted electrochemical reaction, thereby lowering the overall operating cost. The etchant can be tuned/selected to avoid hampering the electrical conductivity and structural stability of the electrode, while still producing a surface of pure (or predominantly pure) catalyst material (e.g., copper). Such etching may be applied to the entirety of the single monolithic electrode structure, or to a portion thereof, such as a portion (including entirety) of the GDL+CAT region.

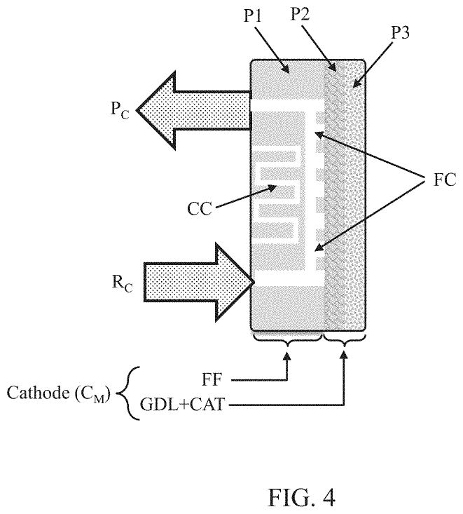

Issues related to electrochemical flow cells may be different depending on a particular type of the cell. Known issues to be addressed in the design of such cells may include water management (e.g., inflow/outflow described above via capillary action) and heat management. It follows that, according to an embodiment of the present disclosure, the single monolithic electrode structure may include cooling channels (e.g., loops) embedded within the electrode. In particular, as shown in FIG. 4, such cooling channels, CC, may be embedded within a volume of the region, FF, of the single monolithic electrode structure (e.g., FIG. 2A, FIG. 3) and fabricated during the AM process (e.g., using known methods and techniques). The cooling channels, CC, may form one or more closed (meandering, serpentine) loops within the volume of the region, FF, wherein the one or more closed loops may be filled and sealed with a working fluid (e.g., coolant). In some embodiments, the cooling channels may connect to an external unit (e.g., heat exchanger) used to cool down a working fluid that circulates through the cooling channels. Such configuration shown in FIG. 4 can therefore allow the thermal management system to become part of the single monolithic electrode structure according to the present teachings.

Teachings according to the present disclosure may take advantage of flexibility provided by AM fabrication techniques that allow for the variation of the input parameters (laser power, scan speed and hatch spacing) continuously throughout the part being fabricated within any three dimensions/directions. Teachings according to the present disclosure may use such flexibility to form a single monolithic electrode structure that comprises non-planar (external or internal) regions/surfaces for an increase in a performance of the electrode, including, for example, an increase in a surface area within a given volume for an increase in a performance of the electrode, an increase in flow of reactants/products, and an increase in structural strength (e.g., pressure withstand capability) of the electrode. One such exemplary implementation is shown in the single monolithic electrode structure (500) of FIG. 5.

As shown in FIG. 5, according to an exemplary embodiment of the present disclosure, the porous region, GDL+CAT, may include a ridged/wavelike (outer) surface, S_{R}, that is configured to interact with the membrane (e.g., EM, having a compliant shape) with an increased surface area compared to the surface area provided by a flat surface (e.g., FIG. 3). Furthermore, as shown in FIG. 5, the porous region, GDL+CAT, may be laterally capped so to contain the reactants and products within the desired (inner) active area. As shown in FIG. 5, such capping may be provided by dense regions (labelled Cap in FIG. 5) surrounding an inner porous region so prevent leaking out of the reactants and products from the edges (e.g., top and bottom regions shown in FIG. 5). It should be noted that although not shown in FIG. 5, the porous region, GDL+CAT, may also extend into the FF region to further promote reactant transport and product removal. In other words, an interface between the two high- and low-density regions, FF and GDL+CAT, may not necessarily be provided by a planar surface, rather any surface shape in view of specific design goals. Furthermore, as shown in FIG. 5, the dense region, FF, can be fabricated such to form domed (e.g., curved) shape (outer) surface, SD, that may advantageously allow an increase in pressure withstand capability of the electrode relative to a planar design.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

1. A monolithic electrode structure for use in an electrochemical flow cell, comprising:
a dense region with embedded flow channels; and
a porous region in contact with the dense region, the porous region configured to interact with the embedded flow channels for distribution of a reactant for an electrochemical reaction through the porous region,
wherein the monolithic electrode structure is made from a metal that includes a catalyst for the electrochemical reaction.

2. The monolithic electrode structure of claim 1, wherein:
the porous region is further configured to interact with the embedded flow channels for removal of a product produced by the electrochemical reaction.

3. The monolithic electrode structure of claim 1, wherein:
a density of the dense region is equal to, or greater than, 90%, and a density of the porous region is smaller than 90%.

4. The monolithic electrode structure of claim 3, wherein:
the density of the porous region is in a range from 25% to 50%.

5. The monolithic electrode structure of claim 1, wherein:
the dense region provides functionality of a flow field layer of the monolithic electrode structure, and
the porous region provides combined functionalities of a gas diffusion layer and catalyst layer of the monolithic electrode structure.

6. The monolithic electrode structure of claim 5, wherein:
an entirety of a volume of the porous region contains catalytic surfaces provided by pores of the porous region.

7. The monolithic electrode structure of claim 5, wherein:
the catalytic surfaces include etched surfaces.

8. The monolithic electrode structure of claim 1, wherein:
a shape of the monolithic electrode structure includes a planar shape with a thickness provided by a thickness of the dense region combined with a thickness of the porous region,
a thickness of the dense region is in a range from about 2 mm to about 1 cm, and
a thickness of the porous region is in a range from about 200 μm to about 400 μm.

9. The monolithic electrode structure of claim 1, wherein:
the porous region includes a first surface that contacts the dense region, and a second surface that is configured to contact a membrane of an electrochemical flow cell, and
pores of the porous region include decreasing or increasing pore sizes between the first and second surfaces.

10. The monolithic electrode structure of claim 9, wherein:
the pore sizes increase in a direction of the first surface so to provide flow of liquid from the second surface to the first surface via capillary action.

11. The monolithic electrode structure of claim 9, wherein:
the pore sizes decrease in a direction of the first surface so to provide flow of liquid from the first surface to the second surface via capillary action.

12. The monolithic electrode structure of claim 1, wherein:
the porous region includes a first surface that contacts the dense region, and a second surface that is configured to contact a membrane of an electrochemical flow cell, and
the porous region includes a plurality of porous regions with different densities, each region of the plurality of porous regions defined by respective surfaces.

13. The monolithic electrode structure of claim 1, wherein:
the dense region further comprises embedded cooling channels for flow of a working fluid, the cooling channels forming a closed loop.

14. The monolithic electrode structure of claim 1, wherein:
the monolithic electrode structure is a cathode for an electrolyzer and the electrochemical reaction is a CO₂ reduction reaction (CO2RR), and
the metal comprises one of: a) copper, b) a copper alloy such as bronze, brass or copper-aluminum, c) tin, d) lead, e) a tin-lead alloy, f) indium, or g) an alloy containing any one of a)-f).

15. The monolithic electrode structure of claim 1, wherein:
the monolithic electrode structure is an anode for an electrolyzer and the electrochemical reaction oxygen evolution (OER), and
the metal comprises one of: i) titanium, ii) platinum, iii) iridium, iv) palladium, v) an oxide of i)-iv), or vi) an alloy containing any one of i)-iv).

16. The monolithic electrode structure of claim 1, wherein:
the monolithic electrode structure is a cathode or an anode for a redox flow battery, and
the metal comprises on of: A) vanadium, B) iron, C) chromium, D) ruthenium, E) nickel, F) zinc, G) cerium, or F) an alloy containing any one of A)-G).

17. An electrochemical flow cell, comprising:
a membrane having a first membrane surface and a second membrane surface;
an anode having a first anode surface in contact with the first membrane surface; and
a cathode having a first cathode surface in contact with the second membrane surface,
wherein each of the anode and the cathode includes a respective monolithic electrode structure that comprises:
a dense region with embedded flow channels, the dense region defining a respective second anode or cathode surface; and
a porous region in contact with the dense region, the porous region configured to interact with the embedded flow channels for distribution of a reactant for an electrochemical reaction through the porous region, the porous region containing the respective first anode or cathode surface,
wherein the respective monolithic electrode structure is made from a metal that includes a catalyst for the electrochemical reaction.

18. The electrochemical flow cell of claim 17, wherein:
a density of the dense region is equal to, or greater than, 90%, and a density of the porous region is smaller than 90%.

19. The monolithic electrode structure of claim 18, wherein:
the density of the porous region is in a range from 25% to 50%.

20. The electrochemical flow cell of claim 17, wherein:
pores of the porous region include decreasing or increasing pore sizes in a direction of the respective first anode or cathode surface.

21. The electrochemical flow cell of claim 17, wherein:
the electrochemical flow cell is an electrolyzer configured to perform an oxygen evolution (OER) at the anode and a CO₂ reduction reaction (CO2RR) at the cathode,
the metal of the respective monolithic electrode structure of the anode includes one of: i) titanium, ii) platinum, iii) iridium, iv) palladium, v) an oxide of i)-iv), or vi) an alloy containing any one of i)-iv), and
the metal of the respective monolithic electrode structure of the cathode includes one of: a) copper, b) a copper alloy such as bronze, brass or copper-aluminum, c) tin, d) lead, e) a tin-lead alloy, f) indium, or g) an alloy containing any one of a)-f).

22. A method for fabricating an electrode for an electrochemical flow cell, the method comprising:
fabricating the electrode as a monolithic structure via additive manufacturing, the additive manufacturing including a laser power bed fusion; and
based on the fabricating, forming in the monolithic structure:
a dense region with embedded flow channels; and
a porous region in contact with the dense region, the porous region configured to interact with the embedded flow channels for distribution of a reactant for an electrochemical reaction through the porous region,
wherein the fabricating includes using a metal that includes a catalyst for the electrochemical reaction.

23. The method according to claim 22, wherein the fabricating further includes:
adjusting one or more parameters of the laser power bed fusion that control a laser power, a scan speed, or a hatch spacing; and
based on the adjusting, controlling a porosity of the porous region.

24. The method according to claim 22, wherein:
an outer surface of the dense region distal the porous region has a shape of a dome.

25. The method according to claim 22, wherein:
an outer surface of the porous region distal the dense region has a ridged shape.
